(19) United States
(12) Patent Application Publication
(10) Pub. No.: US 2023/0202882 A1
(43) Pub. Date: Jun. 29, 2023

(54) Filter head and extension kit for a filter head

(71) Applicant: BWT Holding GmbH, Mondsee (AT)

(72) Inventors: Pierre BALIDAS, Bloomfield, NJ (US); Andrea PAVAN, Cittadella PD (IT); Michael HOFBAUER, Salzburg (AT); Jürgen JOHANN, Mondsee (AT)

(73) Assignee: BWT Holding GmbH, Mondsee (AT)

(21) Appl. No.: 17/910,252

(22) PCT Filed: Feb. 12, 2021
(86) PCT No.: PCT/EP2021/053409

§ 371 Date: Dec. 23, 2022

(30) Foreign Application Priority Data
Mar. 12, 2020 (DE) 10 2020 106 793.3

(51) Int. Cl. C02F 1/42

(52) U.S. Cl. CPC C02F 1/42; C02F 2209/40; C02F 2201/006; C02F 2209/055; C02F 2209/02; C02F 2209/006

(57) ABSTRACT

The disclosure relates to a filter head comprising a housing having one inlet and at least one outlet for being connected to an on-site water pipe. A filter candle having a filter candle inlet and at least one filter candle outlet can be installed in the filter head, and the filter head has means for setting a desired degree of softening by setting a blend ratio. The filter head comprises a flow meter and at least one conductivity measuring device, in particular a conductivity measuring cell, and the filter head has an interface for data transmission to an external unit and an integrated computing unit.

### TECHNICAL FIELD

The disclosure relates to a filter head for a filter candle for water treatment. The disclosure also relates to an extension kit for a filter head.

### BACKGROUND

Systems for water treatment as common in practice, in particular in the home and in gastronomy, comprise a filter head in which a filter candle can be installed. The filter head is connected inline into an on-site, i.e. pressurized, water pipe.

In this filter head, a filter candle is installed which is filled with a medium for water treatment, which contains, for example, an ion exchange material and substances for removing contaminants and bacteria, such as activated carbon.

Such a filter head is known, for example, from Patent Application Publication DE 10 2017 129 559 A1 (BWT AG).

Document EP 3 406 570 A discloses a water softening system which is arranged on a water connection with a filter candle. Document DE 20 2014 106162 A discloses a blending device.

### SUMMARY

A filter candle for water treatment has to be replaced regularly, since the filter medium, in particular the ion exchange material, gets exhausted. Such a replacement can be made based on time elapsed, but this does not take into account the amount of water that has already been treated by the system.

It therefore makes sense to execute the replacement based on the amount of water treated. This amount can be determined using a flow meter, for example, which is installed in the pipe, or by a connected device that includes a flow meter, such as a machine for preparing hot beverages.

In the case of a water meter, the user at least has to remember to check the meter reading on a regular basis.

It is known from the aforementioned system to adjust the degree of softening according to the degree of hardness of the incoming water and the desired softening.

In the aforementioned system, this is achieved using an adjustable bypass that is integrated in the filter head and/or in the filter candle and through which part of the flow can be diverted so as to not pass through the water treatment medium, and which is then mixed with the water that was passed through the water treatment medium. Typically, the bypass is adjusted based on the hardness of the inlet water when the filter head is installed.

However, it will be appreciated that the degree of hardness of the inlet water can change. Furthermore, as stated above, the ion exchange material gets exhausted.

Generally, an ion exchange material, which may in particular come in the form of a weakly acidic ion exchange resin, is used to replace hardness imparting components such as calcium by other ions such as hydrogen.

This involves equilibrium reactions, so that such an exchange depends, among other things, on the percentage degree the ion exchanger is loaded with the exchange ions.

Surprisingly, it is possible to achieve that the exchange stays within a desired window over an elongated period of time. Nevertheless, a significant drop in the softening effect will eventually occur, especially towards the end of the service life of the filter candle. In theory it would be possible to gradually reduce the partial flow routed through the bypass so as to compensate for the decreasing softening effect, in order to extend the service life of the filter candle.

However, this is not very convenient and, in order to be executable in a sensible way, would moreover require continuous verification of the degree of hardness of the output water.

Another problem is that the softening effect also depends to a large extent on the dwell time of the water to be treated inside the filter candle. This may result in an undesirably high degree of softening in spite of the bypass, in particular if only a small amount of water is continuously removed and/or if water is repeatedly removed for only a short moment.

The present disclosure is based on the object of at least mitigating the drawbacks of the prior art.

More particularly it is an object of the disclosure to provide a filter head and a system with a filter head and a filter candle, which can be adjusted conveniently and easily and which provide for a consistent water hardness.

The object is achieved by a filter head, a system comprising a filter head, and by an extension kit for a filter head as claimed.

According to a first aspect, the disclosure relates to a filter head comprising a housing which has one inlet and at least one outlet for being connected into an on-site water pipe.

Hence, the filter head is adapted to be installed inline in a pressurized water installation system. For this purpose, the filter head has an inlet and an outlet, via which it can be connected into the water installation system in a pressure-tight manner.

A filter candle can be installed in the filter head, which has a filter candle inlet and at least one filter candle outlet.

Such a filter candle may have a thread, for example, by way of which the filter candle is connected to the filter head.

The filter candle inlet and the filter candle outlet are in the form of coaxial passages, in particular in the form of a central passage which is surrounded by at least one annular passage.

In this way, the inlet water can be directed from the filter head into the filter candle where it passes through at least one water treatment medium, e.g. an ion exchange material, and flows back through the filter candle outlet and into the filter head to then be further conveyed via the outlet to a tapping point.

Instead of an ion exchange material, the filter candle may also comprise a membrane for reverse osmosis. For such an embodiment, the filter head may comprise a further outlet for discharging the water from the concentrate side.

The filter head furthermore comprises means for setting a desired degree of water hardness by adjusting a blending volume.

The filter head thus comprises at least one means for adjusting the ratio of partial flows of a bypass in relation to a partial flow that is completely passed through the water treatment medium.

The filter head may in particular be configured such that only part of the water to be treated is passed through the filter candle, while the bypass flow is not passed through the filter candle and is therefore not softened. This bypass water can be blended inside the head with the water which has been passed through the filter candle.

Preferably, however, the blending occurs inside the filter candle.

More particularly, it is contemplated that the filter head comprises a control element which engages in the filter candle and changes a ratio of partial flows inside the filter candle using a drive.

In terms of the basic principle, such a system is known, for example, as Applicant's system marketed under the “Bestmax” brand. In this case, a ratio of partial flows inside the filter candle is regulated by the axial displacement of a sleeve that engages into the filter candle and by way of which the bypass can be gradually opened and closed.

This has the advantage that the bypass stream also passes through a section of the filter candle and can at least be passed through a material that removes contaminants, such as activated carbon, for example.

The filter head furthermore comprises a flow meter.

The flow meter allows to measure the volumetric flow passing through the filter head.

Furthermore, the filter head may comprise at least one conductivity measuring device.

The conductivity measuring device allows to determine the conductivity of the inlet water and/or of the outlet water.

It is known to those skilled in the art that the conductivity can be used to infer the degree of hardness of water. Although it is in fact the total concentration of ions what is determined based on the conductivity, the water hardness can be determined in good approximation based on the conductivity, since it depends primarily on the concentration of the dissolved calcium and magnesium ions.

The conductivity measuring device is in particular a conductivity measuring cell which comprises at least two electrodes spaced apart from one another. The electrical resistance of the water can be determined across the electrodes, which in turn allows to derive the water hardness.

In a preferred embodiment, the conductivity measuring device comprises a temperature sensor, since the electrical resistance is a function of temperature. By way of the temperature sensor, the conductivity of the inlet water and/or outlet water can be determined more precisely.

The filter head may also include an interface for data transfer to an external unit.

Furthermore, the filter head may comprise an integrated computing unit.

The integrated computing unit allows to evaluate the signals from the flow meter and, optionally, from the conductivity measuring device.

For example, the integrated computing unit can calculate the current flow rate, the volume of water treated since the filter candle was replaced, and the degree of hardness of the inlet and/or outlet water.

These values can be displayed, for example on a display provided on the filter head, and/or on an external display.

According to one embodiment variation, the filter head includes a display which can display values calculated by the computing unit.

The display may in particular be arranged on a side wall of the housing of the filter head.

Since the filter head itself includes a display, it is not necessary to connect it to an external unit to read the values on the display.

Preferably, the filter head has an integrated power supply for the computing unit and the display. In this way, an electrical connection of the filter head can optionally be dispensed with.

For example, a battery or a rechargeable battery that can be installed in the housing may serve as a power supply.

The interface for data transfer can be used to program the filter head using an external unit, for example for setting the desired degree of hardness of the outlet water.

The obtained measured values can be forwarded to an external unit in a wired or wireless manner.

It is in particular contemplated for the filter head to be able to communicate bidirectionally with a mobile device via a wireless interface, in particular wifi and/or Bluetooth.

The mobile device may have a program installed thereon, which can, for example, display information on the degree of hardness of the inlet and/or outlet water, the current flow rate, the total amount of treated water during a predefined and/or adjustable period of time, etc.

In particular, it is also possible to display, on the mobile device, that a replacement of the filter candle is necessary.

Preferably, the service life of the filter candle is calculated based on the amount of water that passed through the water treatment medium and/or through the filter head as a whole since the last replacement.

Furthermore, the degree of softening can also be accounted for in the calculation, in particular based on the electrical conductivity of the inlet and outlet water.

Moreover, the ratio of partial flows of water directed through the bypass and through the water treatment medium can be included in the calculation. This allows in particular to draw conclusions about the amount of water that passed through the water treatment medium.

The conductivity measurement makes it possible to better exploit the capacity of, for example, an ion exchange material.

In particular in an embodiment in which the blend ratio can be set automatically using the integrated computing unit, the filter head can be capable of gradually reducing the quantity of admixed bypass water as the ion exchange material becomes more and more exhausted, which can significantly extend the service life of a filter candle.

The flow meter, the display, and/or the interface for data transfer to the external unit and the integrated computing unit are preferably integrated in the housing of the filter head.

Hence, no further components are required to be connected to the filter head. A compact configuration of the filter head is still possible.

In a preferred embodiment, a respective conductivity measuring cell is arranged both in the inlet and in the outlet of the filter head.

This allows to precisely calculate the degree of softening and thus the depletion of the ion exchange material.

The at least one conductivity measuring cell may be arranged in a connecting piece or pipe fitting that is connected to the housing of the filter head. More particularly, this can be a detachable pipe fitting, by way of which the filter head can be adapted to different pipe diameters and/or different installation situations.

The integration of the at least one conductivity measuring cell provides for a compact configuration, since the passages defining the inlet and outlet can be used for a measuring cell in which the two measuring electrodes are in particular facing one another.

Furthermore, it is thus possible to easily detach and clean or replace the measuring cells which are sensitive to deposits such as limescale, together with the pipe fitting.

The measuring cell may have an electrical connection or interface which is connected to the integrated computing unit via a cable connection.

According to a further embodiment, the means for setting a desired degree of softening comprise an actuator connected to the computing unit.

By way of the actuator, the blend ratio can be set in an automated manner. This provides for automatic readjustment, for example to compensate for the decreasing softening effect of an ion exchange material during the service life of the filter candle.

Furthermore, the actuator can also be controlled depending on the flow rate. On the one hand, the bypass volume can be increased as the volume flow decreases. This compensates for the longer dwell time of the water to be treated in the ion exchange bed under this condition.

Moreover, measurement curves can be stored on the computing unit. In this way, the computing unit can in particular take into account the amount of water prevailing in the filter candle, so that when a tapping point is opened, the bypass amount is initially increased. This can compensate for the fact that, due to its long dwell time, the water standing in the filter candle will be much more softened than the outlet water during continuous operation.

The actuator may, for example, be in the form of a motorized threaded spindle which moves an actuating element for controlling the blend ratio.

In one embodiment, the at least one conductivity measuring cell, the interface for data transfer to an external unit, and/or the integrated computing unit are arranged in an extension module that can be coupled to the main housing.

According to this embodiment it is possible to easily retrofit a filter head that does not have the functionality of transferring data to external units and/or of measuring the softening effect.

The connectable extension module can in particular be in the form of a housing extension which can be coupled to a main housing.

A programming interface for the computing unit may also be provided on the filter head per se. For example, the exchange of a filter candle and/or a desired degree of hardness of the outlet water can be programmed there.

In one embodiment, the filter head comprises means for detecting a filter candle. More particularly, the filter head may comprise an RFID reading device.

In this way, the filter candle can be identified. More particularly, it is possible to automatically record whether a filter candle has been replaced and, if applicable, what type of filter candle this is. For example, the system can automatically adapt to filter candles with different filter beds. Some filter candles can have a different capacity than a different filter candle, for example due to a different loading of the ion exchange material, and/or due to a different amount of ion exchange material.

The ion exchange material may, for example, be partially loaded with magnesium in order to release magnesium into the water to be treated. A filter candle of this type has a somewhat lower capacity than a filter candle that only comprises ion exchange material loaded with hydrogen.

According to a further aspect, the disclosure relates to a filter head, in particular a filter head with one or more of the features described above.

The filter head comprises a housing with an inlet and at least one outlet for being connected to an on-site water pipe, and a filter candle can be installed in the filter head, which has a filter candle inlet and at least one filter candle outlet.

The filter head furthermore has means for setting a desired degree of softening by setting a blend ratio in accordance with the above definition. More particularly, these means can be configured as described above.

The filter head comprises at least one connecting piece or pipe fitting with a conductivity measuring cell integrated therein.

The at least one pipe fitting is in particular adapted to be detachable from the filter head.

The integration of at least one conductivity measuring cell in the inlet and/or outlet provides for a compact configuration, since, as explained above, an inlet or outlet passage can be optimally used as a measuring cell with opposite electrodes.

On the one hand, a detachable inlet or outlet, in particular a pipe fitting for being connected to an on-site pipe, can allow for retrofitting of a filter head with a conductivity measuring cell.

On the other hand, it allows for easier replacement or cleaning of the conductivity cell.

According to a further aspect, the disclosure relates to a filter head, in particular a filter head with one or more of the features described above.

The filter head comprises a housing with an inlet and at least one outlet for being connected to an on-site water pipe, and a filter candle can be installed in the filter head, which has a filter candle inlet and at least one filter candle outlet. The filter head furthermore comprises means for setting a desired degree of water hardness by setting a blend ratio.

A flow meter is integrated in the housing of the filter head.

The flow meter can in particular comprise a housing with an inlet and an outlet, which is arranged in an extension of the main housing and which is connected between an outlet of a filter candle and the outlet for being connected into the on-site water pipe or between the inlet for being connected into the on-site water pipe and an inlet of a filter candle.

Hence, the flow rate is measured inside the housing of the filter head upstream or downstream of the filter candle.

More particularly, the flow meter can be arranged approximately at the level of the inlet and of the outlet of the filter candle.

This provides for easy integration with short lengths of conduits.

More particularly it is suggested for the main housing of the filter head to comprise connections for the housing of the flow meter.

The flow meter can thus be arranged in a housing extension, for example.

The flow meter may in particular also form part of an extension module.

For example, a filter head can be provided in which the connections for the flow meter are interconnected by a conduit, in particular by a U-shaped piece of pipe.

For retrofitting a flow meter, this piece of pipe can be replaced by the flow meter.

A connectable housing extension may in particular accommodate the flow meter and an integrated computing unit and, optionally, an interface for data transfer.

The integrated computing unit, in turn, can be electrically connected to a conductivity measuring cell which can be provided as part of an extension kit, in particular in the form of an exchangeable pipe fitting.

The flow meter may in particular be in the form of a turbine wheel meter, in particular a radial meter.

In a preferred embodiment, the axis of the turbine wheel is aligned in parallel with the insertion direction of a filter candle.

Thus, in the intended installation position the turbine wheel is arranged vertically and can thus be integrated particularly easily in a compact housing.

Turbine wheel water meters of this type allow for precise measurement over a wide measuring range.

Such a turbine wheel meter is known from Patent Application Publication WO 2019/202134 A1 (BWT AG), for example.

Such a turbine wheel meter can generate a measurement signal, for example by way of an inductive sensor.

According to one embodiment, the flow meter is in the form of a self-contained module that can be connected to passages of the filter head.

It is in particular intended for the module to be plugged to the passages.

More particularly, the module may have two connections arranged in parallel and can thus be plugged into the filter head, in particular from a lateral side.

This makes it easier to retrofit a filter head with a flow meter.

According to an alternative embodiment, the flow meter is installed in an inlet or outlet of the filter head.

This embodiment allows the flow meter to be installed in a very space-saving manner.

The flow meter may in particular comprise a rotating wheel, in particular an impeller wheel, which is mounted in a housing, and the housing is fitted into the inlet or into the outlet of the filter head.

The impeller along with its housing is thus fitted into a connection of the filter head. This provides for easy installation. Moreover, the space that is already available and provided in a connection in the form of a piece of pipe, can be used to accommodate the impeller.

In one embodiment, an interface can be provided on the inlet or outlet, at which the rotation speed of the impeller and/or the flow rate can be tapped.

So, this interface sits on the outside.

The rotation speed of the impeller is preferably transmitted to the interface in a ferromagnetic way. For example, a magnet can be arranged in the impeller, which sweeps past a corresponding sensor area of the interface when the impeller rotates.

An opening in the pipe section of the connection or an electrical feedthrough through the connection can thus be dispensed with.

According to one embodiment, the interface does not include a computing unit, but only allows to tap the rotation speed signal.

According to another embodiment, however, the interface may also include electronics including a computing unit which calculates the flow rate so that it can already be read out at the interface.

The disclosure furthermore relates to a system for water treatment which comprises at least one filter head as described above and a filter candle installed in the filter head.

The filter candle comprises at least one water treatment medium.

Furthermore, the disclosure relates to an extension kit for a filter head, in particular for a filter head with one or more features as described above.

The extension kit comprises a pipe fitting which can be connected to an inlet and/or to an outlet of the filter head, and the pipe fitting comprises a conductivity measuring cell integrated therein.

The extension kit may furthermore include a computing unit and an interface for data transfer to an external unit.

Such an electronic module may in particular be arranged in a detachable housing extension.

Furthermore, a flow meter can also form part of such an extension kit, in particular a flow meter as described above.

### BRIEF DESCRIPTION OF THE DRAWINGS

The subject-matter of the invention will now be explained in more detail by way of exemplary embodiments with reference to the drawings of FIGS. 1 through 23.

FIGS. 1 and 2 are perspective views of a filter head.

FIG. 3 is a perspective view of a filter candle.

FIG. 4 is another perspective view of the filter head.

FIG. 5 is a perspective view of a pipe fitting.

FIG. 6 shows a quick-connect piece which can be used to mount the pipe fitting.

FIG. 7 is a radial sectional view of the pipe fitting.

FIG. 8 is a perspective detail view of the filter head with the housing of the housing extension removed.

FIG. 9 is another perspective detail view.

FIG. 10 is a radial sectional view of the flow meter housing.

FIG. 11 is a view of the filter head in the area of the housing extension, with the flow meter removed so that the circuit board can be seen in full.

FIGS. 12 and 13 are cross-sectional views of the filter head.

FIG. 14 is an axial sectional view of the filter head.

FIGS. 15 and 16 schematically illustrate exemplary embodiments of a filter head which can be coupled to an external unit.

FIGS. 17 to 22 show a further embodiment of a filter head in which a flow meter is integrated in a connection of the filter head.

FIG. 17 is a perspective view.

FIG. 18 is a cross-sectional view.

FIG. 19 is a longitudinal section.

FIG. 20 is a detail view of section A as indicated in FIG. 19.

FIG. 21 is a longitudinal section; and

FIG. 22 is a cross-sectional view of the connecting portion of the filter head.

FIG. 23 shows an embodiment in which the filter candle is in the form of a reverse osmosis system.

### DETAILED DESCRIPTION

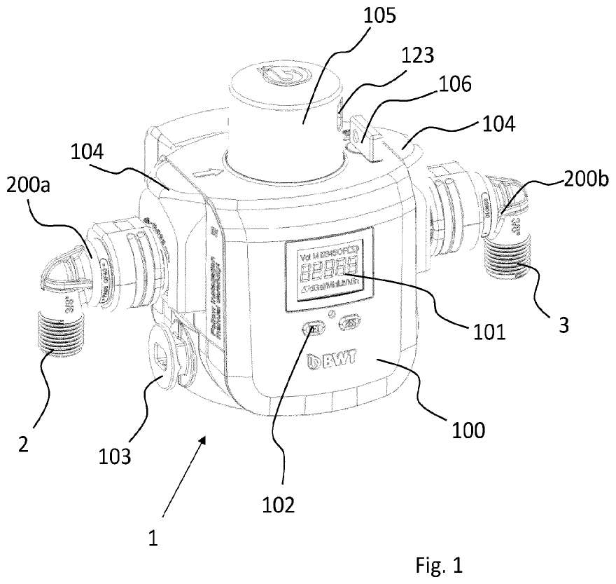

FIG. 1 shows a perspective view of an exemplary embodiment of a filter head 1.

Filter head 1 can be connected inline into an on-site water pipe and has an inlet 2 and an outlet 3 for this purpose.

Inlet 2 and outlet 3 are in the form of detachable pipe fittings 200a, 200b.

Pipe fittings 200a, 200b are angled, and the connections can be mounted in different angular positions relative to the housing 100 of the filter head 1, for adaptation to different installation situations.

In this exemplary embodiment, coupling piece 103 can be used for mounting the filter head housing 100 on a wall mount (not shown).

Pipe fittings 200a, 200b can be detached by twisting off a quick-connect piece 104.

In this exemplary embodiment, the housing 100 of filter head 1 is provided with a display 101 and a control panel 102 at the front.

Display 101 allows to read out the current flow rate, the volume treated since the last replacement of the filter candle, or the degree of hardness of the output water, for example.

Control panel 102 can be used to have the different values displayed, by pressing it multiple times, for example.

Furthermore, control panel 102 may comprise a reset button, for example, which is operable to reset a counter for the service life of the filter candle after the filter candle has been replaced.

According to one exemplary embodiment, filter head 1 comprises an upwardly projecting control element 105, which is operable to manually set the blend ratio in order to adapt the desired softening to the degree of hardness of the inlet water.

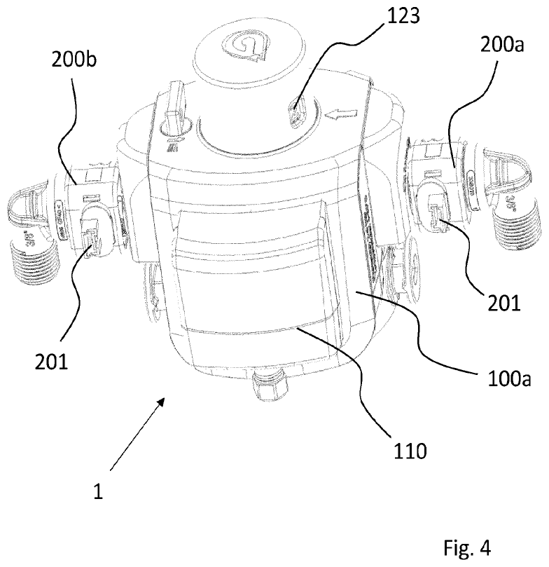

Preferably, however, the blend ratio is automated, for example it is set using a motorized threaded spindle. In this embodiment, an appropriately designed blend ratio indicator 105 may be provided. The indicator 105 may include a window 123 through which the setting of the blend ratio can be read out from a corresponding scale located behind the window 123 (see also FIG. 4).

Furthermore, the filter head 1 comprises the control element 106 for a flushing valve.

When the filter head 101 is installed and the control element 106 is actuated, water will be discharged on the outlet side via a conduit in the form of a piece of hose, for example.

Actuation of the flushing valve primarily serves to flood a newly installed filter candle and then to flush the filter candle thereby discharging suspended matter and allow the exchange reactions in the ion exchange material to become established. The water initially discharged in this way is discarded.

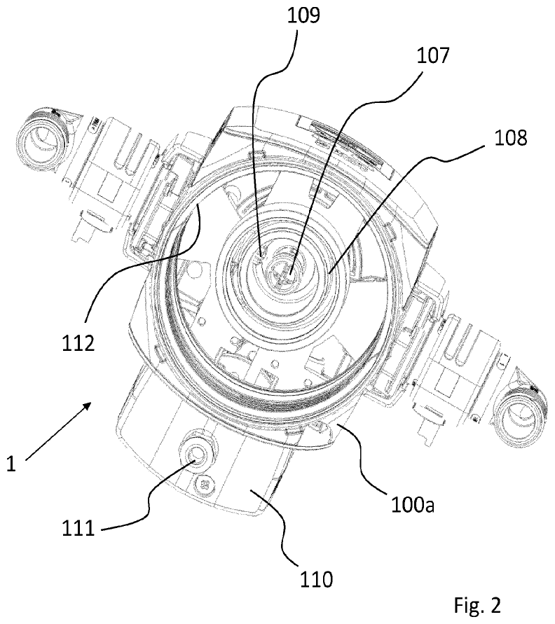

FIG. 2 is a perspective view of the underside of filter head 1.

The filter head comprises a main housing 100a coupled with a housing extension 110. Housing extension 110 is preferably in the form of a housing part that can be detached from the main housing 100a.

In this exemplary embodiment, the housing extension 110 comprises a cable feedthrough 111 which can be used, for example, to couple an external unit such as a display or a programming device to a computing unit integrated in the housing extension 110, and/or to power electrical and electronic components of the filter head 1.

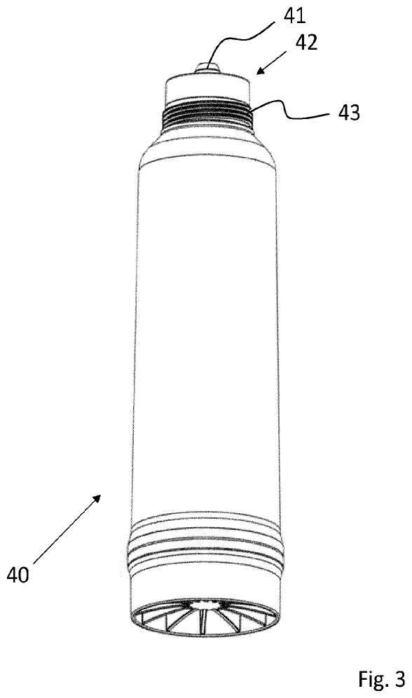

On its underside, the filter head 1 has an internal thread 112 into which the filter candle (see FIG. 3) is screwed.

In this exemplary embodiment, the filter head has a central outlet 107 to the filter candle. Outlet 107 to the filter candle is in the form of a sleeve with at least one passage in this exemplary embodiment.

An annular passage 108 is provided as the inlet 108 for water coming from the filter candle in this exemplary embodiment, which annular passage extends around the outlet 107 to the filter candle.

An actuator 109 for a shut-off valve of the inlet protrudes into this annular passage 108.

When the filter candle is screwed in, the actuator 109 is only pushed back when the filter candle is already joined to the filter head 1 in a sealing manner.

In this way, the water supply is automatically closed when the filter candle is removed and is opened again when the filter candle is installed.

FIG. 3 shows a perspective view of a suitable filter candle 40.

Filter candle 40 comprises a head portion with an external thread.

A central tube defines the inlet 41 of the filter candle, around which an annular passage 42 extends as the outlet.

Water can be introduced into the filter candle 40 via the central downcomer tube of inlet 41, and the water will then flow through the filter medium and will be discharged again at outlet 42.

This central tube may have at least one opening (not shown). The sleeve of the outlet (107 in FIG. 1), which reaches into this tube in the connected state allows to adjust the blend ratio.

Some of the water exits the tube laterally and does not pass through the entire filter section. Rather, this water is preferably only subjected to purification, for example using activated carbon.

FIG. 4 shows a perspective view of the rear side of filter head 1.

The housing extension 110 may form part of an extension kit to supplement the filter head 1 with the additional functionality according to the disclosure or can be removed to retrofit components of an extension kit, in particular a flow meter and/or a computing unit.

Pipe fittings 200a, 200b may also form part of an extension kit.

Pipe fittings 200a, 200b each comprise an electrical interface 201. The electrical interface 201 is in the form of a plug-in connection in this exemplary embodiment.

Electronics arranged in the housing extension 110 can be connected to the electrical interface 201 via a cable connection (not shown).

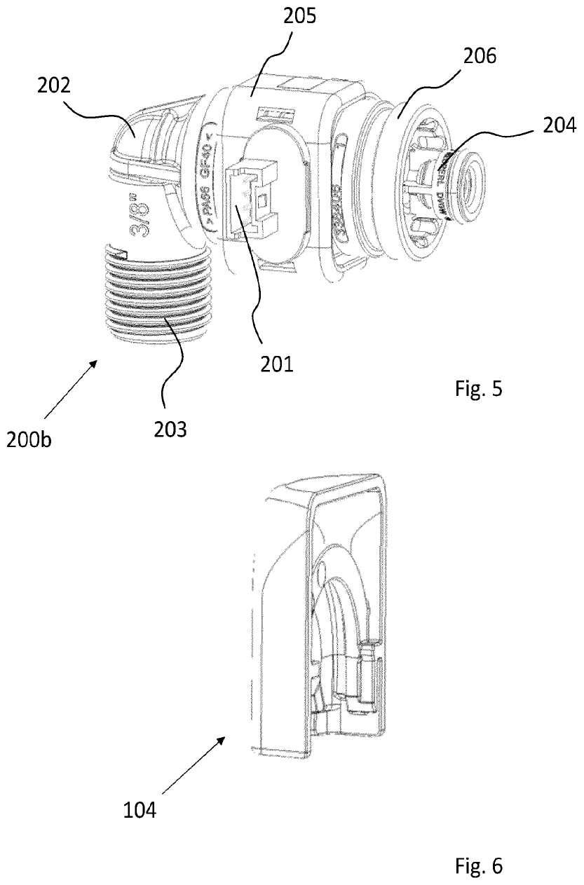

FIG. 5 shows a perspective view of a pipe fitting, namely the pipe fitting 200b of the outlet.

Outlet pipe fitting 200b of the filter head comprises a backflow preventer 204. Due to the backflow preventer 204, no water will escape when the filter candle is removed, since the pipe on the outlet side will run empty.

In this exemplary embodiment, pipe fitting 200b comprises a collar 206, on which the quick-connect 104 as shown in FIG. 6 engages in the connected state, which quick-connect provides for easy removal and connection of the pipe fitting 200b.

Pipe fitting 200b comprises an integrated conductivity measuring cell 205 which includes the electrical interface 201.

Pipe fitting 200b furthermore has the form of an angle piece or elbow 202. A straight pipe fitting is also possible.

The connection 203 for an on-site pipe can be in the form of a thread, for example.

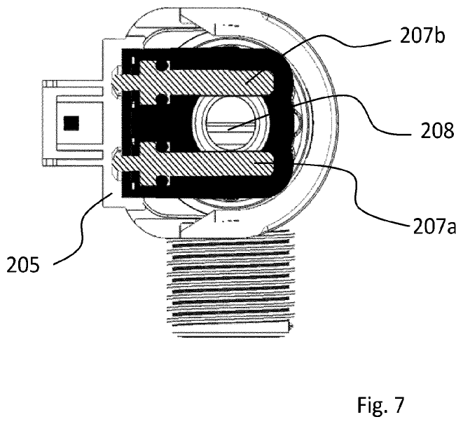

FIG. 7 is a cross-sectional view of the pipe fitting in the area of the conductivity measuring cell 205.

Conductivity measuring cell 205 comprises two opposing electrodes 207a, 207b protruding into the passage 208 that is defined by the pipe fitting.

Furthermore, the conductivity measuring cell 205 includes a temperature sensor, not shown.

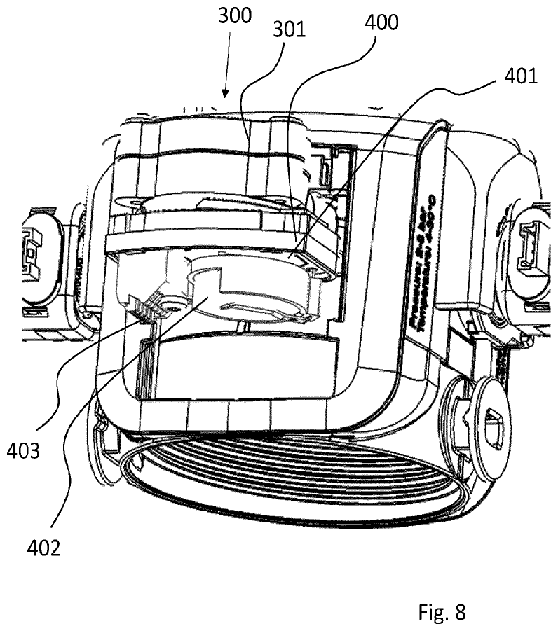

FIG. 8 is a perspective detailed view of the rear side of the filter head with the housing extension (110 in FIG. 4) removed.

A flow meter 300 comprising the housing 301 is integrated in the housing extension.

Below the flow meter, a computing unit 400 is located, which includes a circuit board 401.

Circuit board 401 has an interface 403, for example for the conductivity measuring cells.

In this exemplary embodiment, circuit board 401 comprises a battery 402 which may in particular be in the form of a button cell.

As contemplated according to one embodiment, the battery 402 can serve to power the computing unit 400.

According to a further exemplary embodiment it is also possible to power the computing unit via a cable, and the battery 402 is only provided in order to avoid data loss in the event of a power interruption on the mains side.

The computing unit 400 and the housing 301 of flow meter 300 are stacked one on top of the other. This provides for a compact design and the arrangement of signal processing components for the flow meter 300 directly on the circuit board 401.

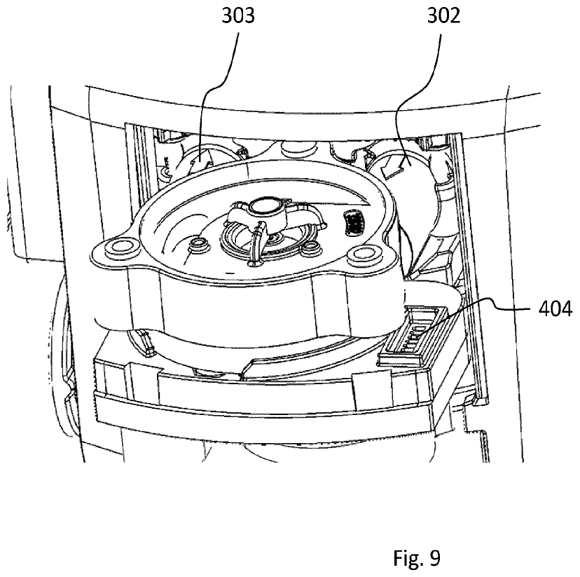

FIG. 9 is another perspective view of the flow meter section with an upper housing portion of the flow meter removed.

As can be clearly seen in this view, the flow meter has an inlet 302 and an outlet 303. Water flows through the flow meter via inlet 302 and outlet 303.

Since the inlet 302 and the outlet 303 are arranged in parallel to one another, it is easily possible to connect a U-shaped pipe piece to the respective connections instead of the flow meter.

In this way, a filter head can be provided without a flow meter, and can be easily enhanced to include the flow meter by replacing the pipe piece by the flow meter.

The flow meter comes in the form of a self-contained module which can be fitted or plugged to the connections (passages 114 and 115) of the filter head with its inlet 302 and outlet 302.

The circuit board has a further electrical interface 404 which is used, for example, to connect the display (101 in FIG. 1).

The connecting line for the display (not shown) can be routed through the housing of the filter head, in particular along the side wall of the housing.

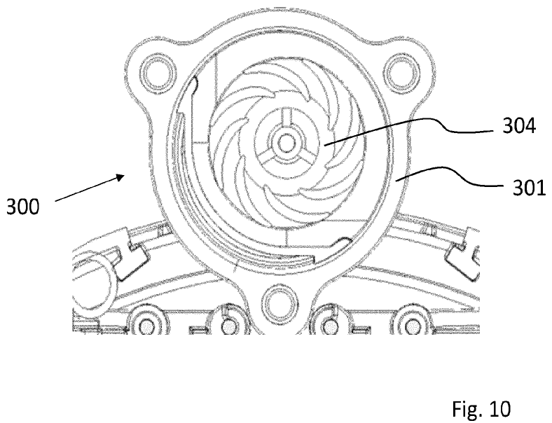

FIG. 10 is a cross-sectional view of the filter head in the area of the flow meter 300.

Flow meter 300 includes a turbine wheel 304 which is arranged as a radial turbine and sits flat in the housing 301.

Such a flow meter 300 is of compact design, provides an exact measurement result and causes only relatively small flow loss.

Furthermore, for generating a measurement signal, the turbine wheel 304 may comprise at least one magnet or a ferromagnetic insert (not shown).

In this way, the rotation speed of the turbine wheel 304 and hence the flow rate can be measured using an inductive sensor. A corresponding calibration curve can be stored in the computing unit.

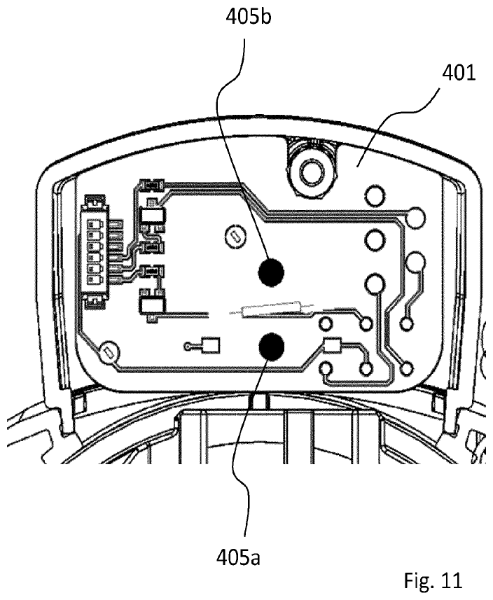

FIG. 11 shows the circuit board 401 arranged in the housing extension of the filter head, while the flow meter has been removed here.

The board 401 itself can include sensor areas 405a, 405b.

Sensor areas 405a, 405b may form part of an integrated inductive sensor, for example, so as to directly capture the rotation speed of the turbine wheel of the flowmeter.

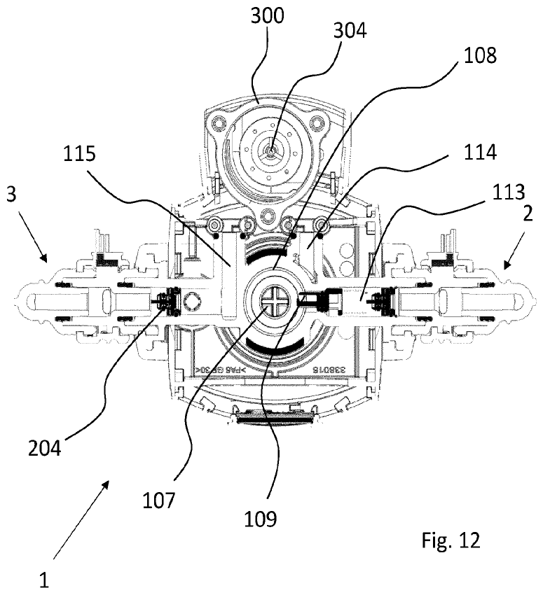

FIG. 12 is a cross-sectional view of the filter head 1 in the area of the connections (2, 3) thereof, this view being shown as seen from below.

More particularly, the central outlet 107 to the filter candle can be seen, around which the inlet for water flowing from the filter candle extends in the form of a annular passage 108.

The actuator 109 for inlet valve 113, through which the inlet 2 is closed when the filter candle is removed, protrudes into this annular passage 108.

The water flowing out of the filter candle flows via the outwardly extending passage 114 into the flow meter 300 and causes the turbine wheel 304 to move as a function of the flow rate.

The axis of the turbine wheel 304 is aligned in parallel with the insertion direction of the filter candle and therefore parallel to the outlet 107 and to the inlet 108.

The housing lying flat like this facilitates a compact design.

From flow meter 300, the water flows via passage 115 to the outlet 3, also at about the same level.

The sectional view shows the backflow preventer 204 which keeps the outlet 3 closed when the filter candle is removed, so that no water flows back.

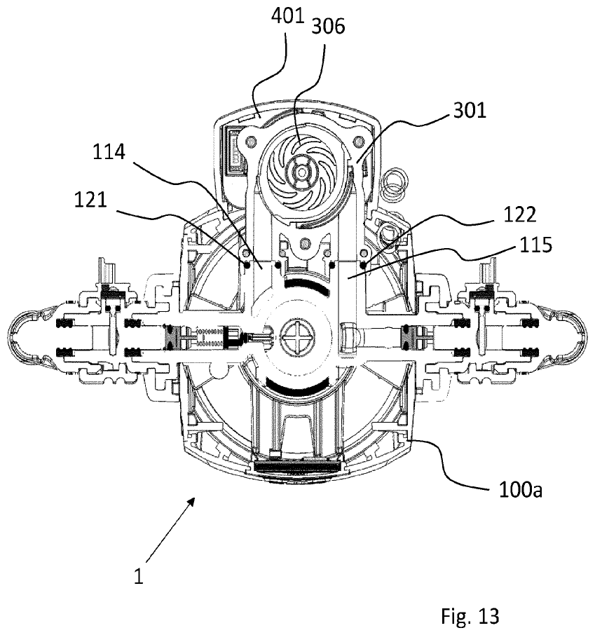

FIG. 13 is another cross-sectional view of the filter head 1, now showing a view as seen from above.

As can be clearly seen in this sectional view, the passages 114, 115 to and from turbine wheel 304 are defined by the housing 301 as well as by the conduits located in the main housing 100a.

In this way, the housing 301 of the flow meter is connected to the passages of the filter head in a sealing manner using seals 121 and 122.

Furthermore, it can be seen that the housing 301 is placed directly on the circuit board 401.

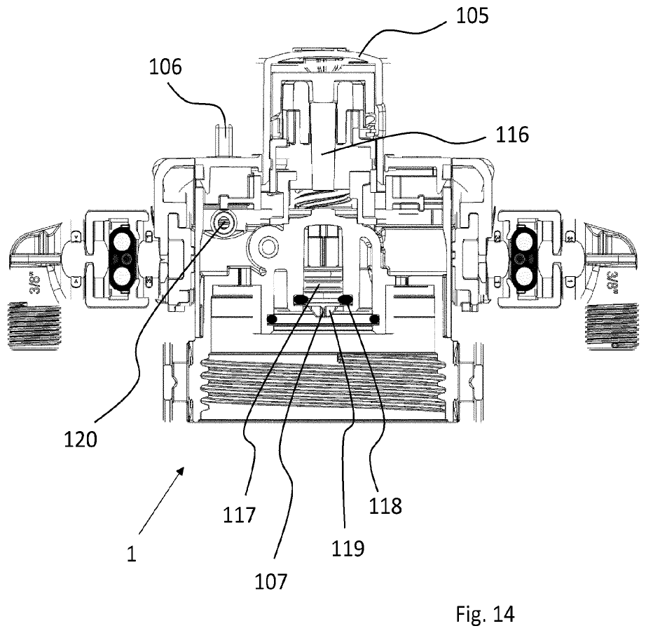

FIG. 14 is an axial sectional view of the filter head.

As can be seen in this sectional view, the outlet 107 to the filter candle comprises a sleeve 117 with at least one passage 119.

Sleeve 117 comprises a seal 118 and engages in the central tube of the filter candle when connected.

Sleeve 117 can be displaced axially by a threaded spindle 116 which can be driven by a servomotor (not visible in this view), and threaded spindle 116 is connected to the bypass indicator 105.

Depending on the position of the sleeve 117, a different number of holes will be opened or closed in the downcomer tube of the filter candle as a function of the axial position of the sleeve 117, or the cross section of an elongated hole will be opened more or less laterally. In this way, the blend ratio can be adjusted.

The hose connection 120 can also be seen, to which a hose can be connected in order to drain off output water which emerges when the flushing valve is actuated.

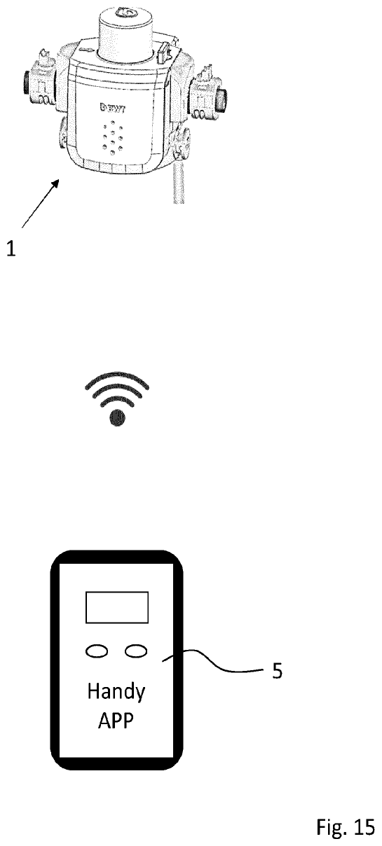

FIG. 15 schematically shows a filter head 1 which does not comprise its own display device in this embodiment.

Otherwise, however, filter head 1 can be configured as in the exemplary embodiment described above.

Filter head 1 comprises a wireless communication means, for example Bluetooth or wifi, so that it is able to establish a data connection with a mobile device 5.

A program running on mobile device 5 permits to derive data such as the degree of hardness, amount of water etc.

Also, the predicted remaining service life of the filter candle can be displayed.

Finally, it is possible to change the desired degree of softening, which can be determined relatively precisely by the conductivity measuring cells at the inlet and outlet.

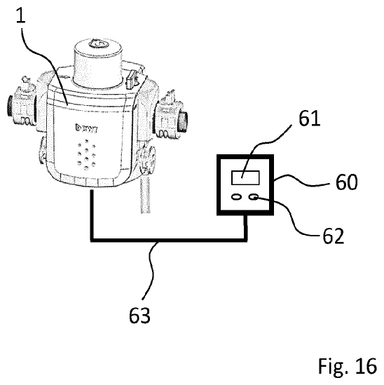

FIG. 16 shows an embodiment in which the filter head 1 is connected to an external unit 60 via a cable.

The external unit may include a display 61 and/or a control panel 62. The cable 63 can, for example, be connected to the computing unit via the cable feedthrough (111) as shown in FIG. 2.

The functionality of display 61 and control panel 62 may correspond to that of the embodiment shown in FIG. 1 with a display on the filter head.

The connection via cable 63 has the advantage that the external unit 60 can be mounted at a different location.

More particularly, the filter head may be located under the sink, for example in gastronomy, whereas the external unit 60 is mounted above the sink so as to be easily accessible, for example on a wall.

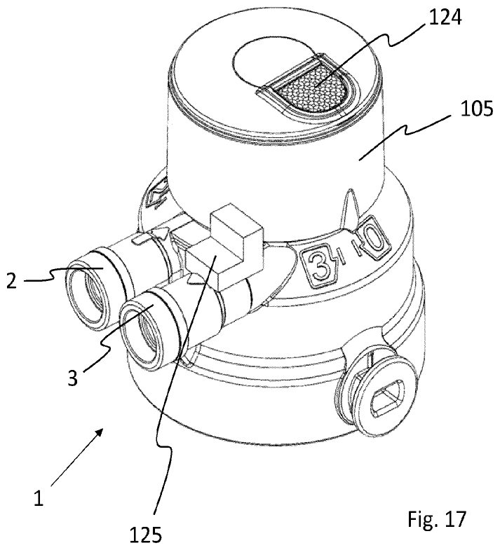

FIG. 17 shows a perspective view of a further exemplary embodiment of a filter head 1.

Filter head 1, like the filter heads illustrated before, is adapted for having a filter candle installed and is connected to an existing on-site water pipe.

Filter head 1 has an inlet 2 and an outlet 3.

In this exemplary embodiment, inlet 2 and outlet 3 are arranged next to one another and extend parallel to one another. Thus, the filter head 1 is connected from one lateral side in this embodiment. However, a different configuration is also conceivable.

For setting the blend ratio, the filter head 1 comprises a control element 105 which is designed to be rotatable in order to adjust a bypass.

In this exemplary embodiment, the control element 105 can only be turned when the locking means 124 is pressed.

The essential difference compared to the exemplary embodiments described above is that in this exemplary embodiment a flow meter is integrated in a connection, in this exemplary embodiment in the outlet 3.

On the outside, the outlet 3 has an electrical interface 125 fitted thereto, which allows to capture at least the rotation speed of an impeller of the flow meter and to thus forward it to an external unit.

In order to provide further functionalities for the filter head 1 shown here, it is possible to mount a pipe fitting including a conductivity measuring cell to the inlet 2 and/or to the outlet 3, for example a pipe fitting as illustrated in FIG. 4 and FIG. 5 (200a, 200b).

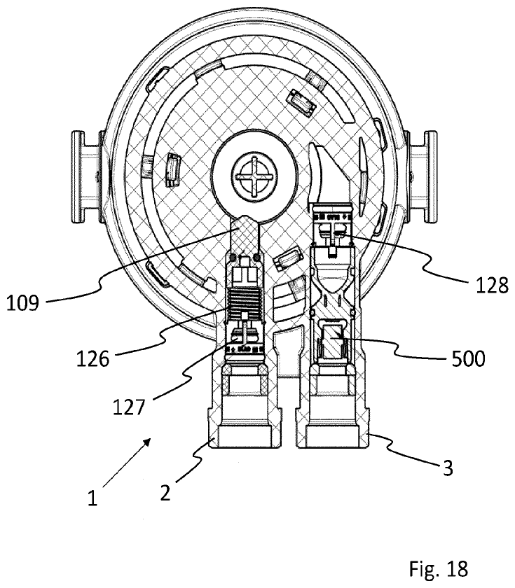

FIG. 18 shows a cross-sectional view of filter head 1, cut centrally through the connection portions, i.e. through inlet 2 and outlet 3.

As in the exemplary embodiment illustrated above, an actuator 109 is provided downstream of inlet 2, which is actuated by the head portion of the filter candle and thus opens a check valve 126 when the filter candle is installed.

A backflow preventer or non-return valve 127 may be provided upstream of the check valve 126.

On the outlet side, another backflow preventer 128 is first provided downstream of the filter candle.

Within the pipe section of outlet 3, the outflowing water flows over a flow meter 500, the configuration of which will be described in more detail below.

The integration of the flow meter 500 into a pipe fitting provides for a particularly compact design.

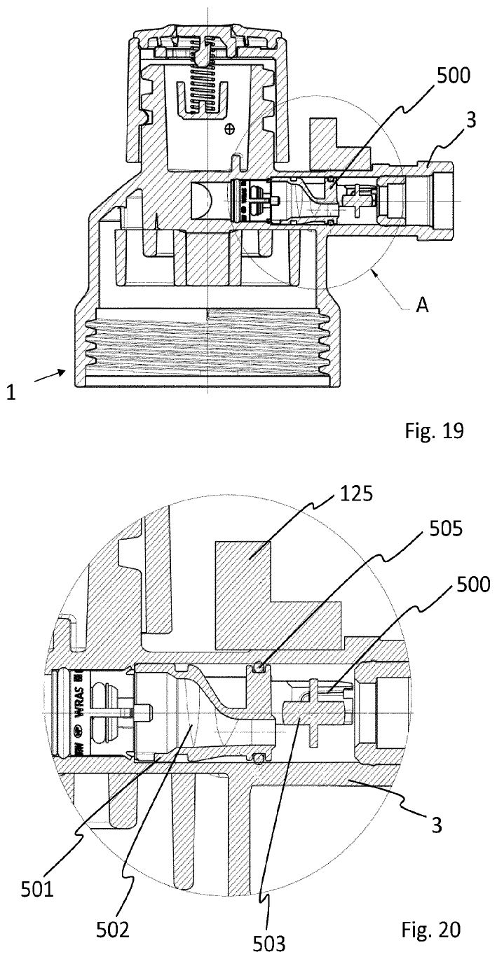

FIG. 19 is a longitudinal section of the filter head 1, cut centrally through outlet 3.

It can be seen that the flow meter 500 sits inside the connection which has the form of a pipe.

FIG. 20 is a detail view of section A as indicated in FIG. 19.

The flow meter 500 comprises an impeller 503 which is mounted in a housing 501 that is fitted into the pipe portion of outlet 3.

Thus, the flow meter 500 can be installed particularly easily.

The housing 501 can be latched in the pipe portion, for example, and/or can be clamped using a seal 505.

Housing 501 includes a passage 502 with a cross section tapering towards the side of outlet 3, so that the impeller 503 is subjected to the flow at one side.

The impeller 503 may include a magnet (not shown) integrated therein. The rotation speed of the impeller 503 can thus be read out in a contactless way from the outside via interface 125.

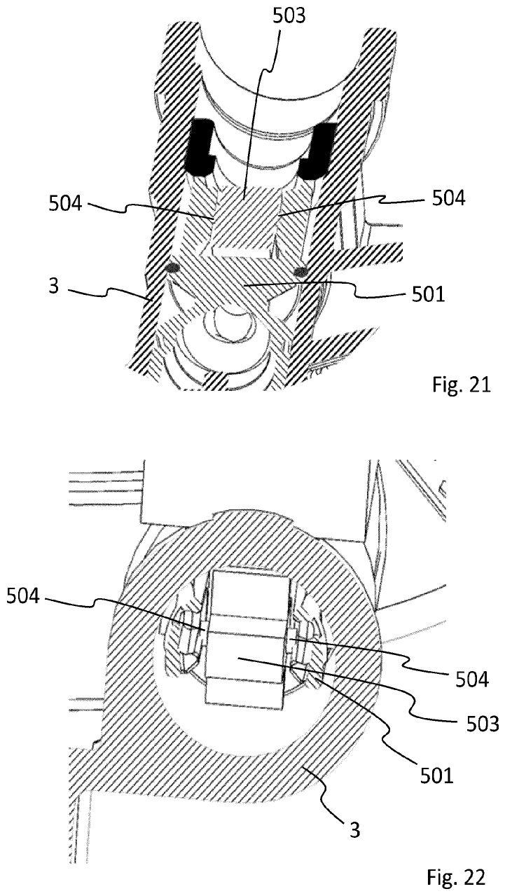

FIG. 21 is a longitudinal sectional detail view of outlet 3.

It can be seen that, inside the housing 501, the impeller 503 is mounted laterally by bearings 504, perpendicular to the flow direction.

FIG. 22 is a cross-sectional detail view of the connection 3 immediately downstream of impeller 503. The bearings 504 are in the form of shafts which are mounted in corresponding circular holes of the housing 501.

The impeller 503 can be mounted, for example, by first latching it into the housing 501 and then slidingly introducing it into the connection 3 together with the housing.

The filter head illustrated in FIGS. 17 to 22 is in particular adapted for communication with an external unit.

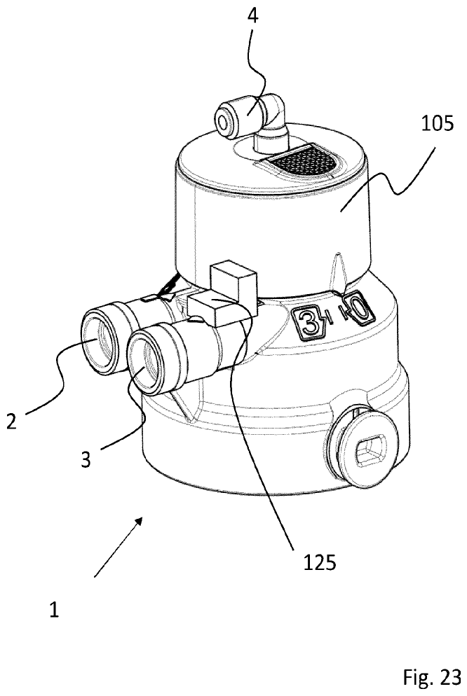

FIG. 23 is a perspective view of a filter head 1 adapted for a filter candle which includes a reverse osmosis membrane (not shown).

Instead of flowing through a filter bed for being softened, the inlet water is directed through a membrane.

The concentrated inlet water then has to be discharged on a concentrate side.

The water on the concentrate side is discharged via a further outlet 4.

In this exemplary embodiment, the further outlet 4 is implemented in the center of the control element 105.

Otherwise the filter head corresponds to the exemplary embodiment explained with reference to the drawings of FIGS. 17 through 22.

Hence, an electrical interface 125 is provided at outlet 3, which allows to read out the signal of a flow meter.

The configuration of the flow meter together with interface 125 corresponds to the illustration according to FIGS. 20 to 22.

The invention allowed to provide a filter head that is conveniently actuable and adjustable, while at the same time providing for a more consistent water hardness and a longer service life of the filter candle.

### LIST OF REFERENCE NUMERALS

1 Filter head
2 Inlet
3 Outlet
4 Outlet for concentrate
40 Filter candle
41 Filter candle inlet
42 Filter candle outlet
43 External thread
5 Mobile device
60 External unit
61 Display
62 Control panel
63 Cable
100 Housing
100a Main Housing
101 Display
102 Control panel
103 Coupling piece
104 Quick-connect/quick-connect piece
105 Control element/blend ratio indicator
106 Control element for flushing valve
107 Outlet into filter candle
108 Inlet for water flowing out of the filter candle
109 Actuator for inlet shut-off valve
110 Housing extension
111 Cable feedthrough
112 Internal thread
113 Inlet valve
114 Passage to flow meter
115 Passage from flow meter
116 Threaded spindle
117 Sleeve
118 Seal
119 Passage
120 Hose connection
121 Seal
122 Seal
123 Window
124 Locking means
125 Electrical interface
126 Check valve
127 Backflow preventer
128 Backflow preventer
200a, b Pipe fitting with conductivity measuring cell
201 Electrical interface
202 Angle piece
203 Connection for on-site pipe
204 Backflow preventer
205 Conductivity measuring cell
206 Collar
207a,b Electronics
208 Passage
300 Flow meter
301 Housing
302 Inlet
303 Outlet
304 Turbine wheel
400 Computing unit
401 Circuit board
402 Battery
403 Electrical interface
404 Electrical interface
405a,b Sensor area
500 Flow meter
501 Housing
502 Passage
503 Impeller
504 Bearing
505 Seal

1.-20. (canceled)

21. A filter head, comprising:
a housing with an inlet and an outlet for being connected into an on-site water pipe;
a filter candle installed in the filter head, the filter candle having
a filter candle inlet and
a filter candle outlet,
wherein the filter candle inlet and the filter candle outlet are coaxial passages;
means for setting a desired degree of softening by setting a blend ratio;
a flow meter and a computing unit; and
a display adapted for indicating values calculated by the computing unit.

22. The filter head as in claim 21, further comprising
a conductivity measuring cell.

23. The filter head as in claim 22, further comprising
an interface for data transfer to an external unit.

24. The filter head as in claim 23,
wherein the flow meter, the interface for data transfer to the external unit, and the computing unit are integrated in the housing of the filter head.

25. The filter head as in claim 21,
with a respective conductivity measuring cell arranged in the inlet and in the outlet; and/or
with at least one conductivity measuring cell arranged in a pipe fitting connected to the filter head housing.

26. The filter head as in claim 21,
wherein the means for setting a desired degree of softening comprise an actuator connected to the computing unit.

27. The filter head as in claim 23,
wherein the conductivity measuring cell, the interface for data transfer to an external unit, and/or the computing unit are arranged in an extension module that can be coupled to a main housing.

28. The filter head as in claim 27,
wherein the conductivity measuring cell comprises a temperature sensor; and/or
wherein a programming interface for the computing unit is provided on the filter head and/or on the external unit; and/or
wherein the filter head has means for detecting a filter candle, in particular an RFID reading device.

29. A filter head, comprising
a housing with an inlet and an outlet for being connected into an on-site water pipe,
wherein the filter head is adapted for installing a filter candle therein, which has a filter candle inlet and a filter candle outlet,
wherein the filter candle inlet and the filter candle outlet are coaxial passages, wherein the filter head has means for setting a desired degree of softening by setting a blend ratio,
wherein the filter head comprises at least one pipe fitting with a conductivity measuring cell integrated therein.

30. A filter head, comprising:
a housing with one inlet and at least one outlet for being connected into an on-site water pipe,
wherein the filter head is adapted for installing a filter candle therein, which has one filter candle inlet and at least one filter candle outlet,
wherein the filter candle inlet and the filter candle outlet are coaxial passages,
wherein the filter head has means for setting a desired degree of softening by setting a blend ratio,
wherein the housing of the filter head includes a flow meter integrated therein.

31. The filter head as in claim 30,
wherein the flow meter comprises a housing with an inlet and an outlet, which is arranged in an extension of a main housing and which is connected between an outlet of a filter candle and the outlet for being connected into the on-site water pipe or between the inlet for being connected into the on-site water pipe and an inlet of a filter candle.

32. The filter head as in claim 21,
wherein the flow meter is arranged approximately at a level of the inlet and of the outlet of the filter candle.

33. The filter head as in claim 21,
wherein the flow meter is a turbine wheel meter, with a turbine wheel axis aligned in parallel to an insertion direction of a filter candle.

34. The filter head as in claim 21,
wherein the flow meter is a self-contained module that can be connected to passages of the filter head.

35. The filter head as in claim 34,
wherein the module can be plugged to the passages.

36. The filter head as in claim 30,
wherein the flow meter is installed in an inlet or in an outlet of the filter head.

37. The filter head as in claim 36,
wherein an interface is provided on the inlet or on the outlet, at which a rotation speed of an impeller wheel and/or a flow rate can be tapped.

38. The filter head as in claim 36,
wherein the flow meter comprises a rotating wheel, in particular an impeller wheel, which is mounted in a housing, wherein the housing is fitted into the inlet or into the outlet of the filter head.

39. A system for water treatment,
comprising the filter head as in claim 21 and a filter candle installed in the filter head, which comprises at least one water treatment medium.

40. The system as in claim 39, further comprising
an extension kit for the filter head, comprising a pipe fitting which can be connected to an inlet and/or to an outlet of the filter head, wherein the pipe fitting comprises a conductivity measuring cell integrated therein.
